(19) United States
(12) Patent Application Publication
(10) Pub. No.: US 2014/0268859 A1
(43) Pub. Date: Sep. 18, 2014

(54) Apparatus and Method of Precision-Controlled Distribution of Lighting of High Uniformity

(71) Applicants: Gerald Ho Kim, Carlsbad, CA (US); Jay Eunjae Kim, Issaquah, WA (US)

(72) Inventors: Gerald Ho Kim, Carlsbad, CA (US); Jay Eunjae Kim, Issaquah, WA (US)

(21) Appl. No.: 13/831,518

(22) Filed: Mar. 14, 2013

(51) Int. Cl. F21V 8/00

(52) U.S. Cl. CPC G02B 6/0096
USPC 362/553; 362/551; 362/555; 219/121.85; 451/28; 427/163.2

(57) ABSTRACT

An apparatus for illumination is provided. In one aspect, the apparatus comprises a light guide device including a hollow light pipe portion, an opening, and a distal end longitudinally opposite from the opening. The opening is configured to receive at least a portion of an illumination device therein. Either or both of the light pipe portion and the distal end has a textured surface thereof.

### BACKGROUND

1. Technical Field

The present disclosure generally relates to the field of lighting and, more particularly, to the control of distribution of light-emitting diode (LED) lighting of high uniformity.

2. Description of the Related Art

Compared with conventional light sources such as ordinary incandescent light bulbs and halogen lamps, LEDs generally offer a number of advantageous characteristics such as longer product life, more compact size, higher shock resistance, lower heat generation and lower power consumption, etc. As a result LEDs are widely employed in a variety of applications as the light source for illumination or indicator of a variety of equipment. Recent developments of new LEDs are in the areas of multiple colors and high brightness. Accordingly, LEDs are further employed in applications such as large outdoor bulletin boards, traffic signals and related fields. In the future, LEDs may even become the primary light source for illumination that not only conserve electricity but also are environmentally friendly.

One trend is to use LEDs as a light source for illumination in medical applications. For instance, surgical headlights based on LEDs for use by surgeons have recently been introduced to the market. However, existing medical applications as well as portable applications of LEDs tend to have one or more of the following problems: non-uniformity of illumination from LED, less-than-desirable reliability of the LED due to thermal problem (e.g., inadequate heat dissipation from the LED), imprecise distribution of LED lighting, glare, poor contrast from LED lighting, etc.

There is, therefore, a need to resolve at least some of the aforementioned problems related to LED lighting in medical and other similar applications.

### SUMMARY

Various embodiments of an apparatus for illumination are provided.

According to one aspect, an apparatus may comprise a light guide device that includes a hollow light pipe portion, an opening, and a distal end longitudinally opposite from the opening. The opening may be configured to receive at least a portion of an illumination device therein. Either or both of the light pipe portion and the distal end may have a textured surface thereof.

In some embodiments, an external surface or an internal surface, or both the external and internal surfaces, of a first section of the light pipe portion may be textured. Additionally, the external surface or the internal surface, or both the external and internal surfaces, of a second section of the light pipe portion may be non-textured.

In some embodiments, an external surface or an internal surface, or both the external and internal surfaces, of a first section of the light pipe portion may be textured in a first pattern. Additionally, the external surface or the internal surface, or both the external and internal surfaces, of a second section of the light pipe portion may be textured in a second pattern different than the first pattern.

In some embodiments, an external surface or an internal surface, or both the external and internal surfaces, of the distal end may be textured in a first pattern. Additionally, an external surface or an internal surface, or both the external and internal surfaces, of at least a section of the light pipe portion may be textured in a second pattern different than the first pattern.

In some embodiments, the textured surface may comprise a scratched surface.

In some embodiments, the textured surface may comprise a painted surface.

In some embodiments, the textured surface may comprise a surface with optical coating.

In some embodiments, the textured surface may comprise a surface-machined surface.

In some embodiments, the textured surface may comprise a two-dimensional texture. Additionally or alternatively, the textured surface may comprise a three-dimensional texture.

In some embodiments, the light guide device may be made of a thermoplastic material. The thermoplastic material may be acrylic or a type of polycarbonate material. Alternatively, the light guide device may be made of glass or another transparent material.

In some embodiments, the apparatus may further comprise a first illumination device. A portion of the first illumination device is received in the opening of the light guide device.

In some embodiments, the first illumination device may comprise an LED or an laser diode (LD).

In some embodiments, the apparatus may further comprise a power supply coupled to provide electric power to the first illumination device.

In some embodiments, the power supply may comprise an alternating current (AC) power adapter and a power converter to convert an AC power to a direct current (DC) power.

In some embodiments, the power supply may comprise a battery.

According to another aspect, an apparatus may comprise an illumination device, a power supply coupled to provide electric power to the illumination device, and a light guide device. The light guide device may include a hollow light pipe portion, an opening, and a distal end longitudinally opposite from the opening. The opening may be configured to receive at least a portion of the illumination device therein. Either or both of the light pipe portion and the distal end may have a textured surface thereof.

In some embodiments, a first section of the light pipe portion may be non-textured, the external surface or the internal surface, or both the external and internal surfaces, of a second section of the light pipe portion may be textured in a first pattern, and an external surface or an internal surface, or both the external and internal surfaces, of the distal end may be textured in a second pattern different than the first pattern.

According to a further aspect, a method of manufacturing a portion of an illumination apparatus may comprise providing a light guide device having a hollow light pipe portion, an opening configured to receive an illumination device therein, and a distal end longitudinally opposite from the opening. The method may further comprise texturing a respective surface of either or both of the light pipe portion and the distal end.

In some embodiments, texturing a respective surface of either or both of the light pipe portion and the distal end may comprise texturing the respective surface of either or both of the light pipe portion and the distal end by at least one of the following: scratching the respective surface, painting the respective surface, optical-coating the respective surface, surface-machining the respective surface, texturing the respective surface by laser, or melting the respective surface by laser.

This summary is provided to introduce concepts relating to an apparatus for illumination. The proposed techniques are further described below in the detailed description. This summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a perspective view of an unassembled apparatus that provides precision-controlled distribution of LED lighting of high uniformity in accordance with one embodiment of the present disclosure.

FIG. 2 is a side view of the unassembled apparatus of FIG. 1 in accordance with one embodiment of the present disclosure.

FIG. 3 is a perspective view of a light guide device in accordance with one embodiment of the present disclosure.

FIG. 4 is a side view of the light guide device of FIG. 3 in accordance with one embodiment of the present disclosure.

FIG. 5 is a perspective view of another light guide device in accordance with one embodiment of the present disclosure.

FIG. 6 is a side view of the light guide device of FIG. 5 in accordance with one embodiment of the present disclosure.

FIG. 7 is a side view of the apparatus of FIG. 1 in operation in accordance with one embodiment of the present disclosure.

FIG. 8 is a process of manufacturing a portion of an illumination apparatus in accordance with one embodiment of the present disclosure.

### DETAILED DESCRIPTION OF PREFERRED EMBODIMENTS

### Overview

The present disclosure describes embodiments of an apparatus that provides precision-controlled distribution of LED lighting of high uniformity. The disclosed apparatus comprises a light guide device that includes a hollow light pipe portion, an opening, and a distal end longitudinally opposite from the opening. The opening is configured to receive an illumination device, such as an LED-based light source. Either or both of the light pipe portion and the distal end includes a textured surface thereof. The non-textured sections of the light pipe portion tend to result in total internal reflection of the light emitted from the illumination device. However, with one or more sections of the light pipe portion or the distal end, or both, being textured, light emitted from the illumination device will traverse or emit out of the light guide device through the textured sections. Such emitted light tends to have high uniformity. Therefore, desired illumination can be achieved by appropriate size and location of the textured sections on either or both of the light pipe portion and the distal end. The embodiments may also be implemented in applications where the light source is one or more laser diodes.

While aspects of the disclosed embodiments and techniques may be implemented in any number of different applications, for the purpose of illustration the disclosed embodiments are described in context of the following exemplary configurations.

### Illustrative Apparatus

FIGS. 1-2 illustrate an unassembled apparatus 1001 in accordance with one embodiment of the present disclosure. FIGS. 3-4 illustrate a light guide device 30 in accordance with one embodiment of the present disclosure.

The apparatus 1001 comprises a light guide device 25. In some embodiments, the apparatus 1001 further comprises an illumination device 12. Although FIGS. 1-2 illustrate both the light guide device 25 and the illumination device 12, in some embodiments the apparatus 1001 comprises the light guide device 25 but not the illumination device 12, and in other embodiments, the apparatus 1001 comprises both the light guide device 25 and the illumination device 12.

As shown in FIGS. 1-2, the light guide device 25 includes a hollow light pipe portion 27, an opening 26 on one end of the light guide device 25, and a distal end 28 that is longitudinally opposite from the opening 26 on the other end of the light guide device 25. The opening 26 is configured to receive at least a portion of the illumination device 12 therein. As shown in FIGS. 3-4, the light guide device 30 includes a hollow light pipe portion 37, an opening 36 on one end of the light guide device 30, and a distal end 38 that is longitudinally opposite from the opening 36 on the other end of the light guide device 30. The opening 36 is configured to receive at least a portion of the illumination device 12 therein. The following description refers to FIGS. 1-2 and FIGS. 3-4.

In some embodiments, an external surface or an internal surface, or both the external and internal surfaces, of a first section of the light pipe portion 27 is textured. Additionally, the external surface or the internal surface, or both the external and internal surfaces, of a second section of the light pipe portion 27 is non-textured. For example, as shown in FIGS. 1-2, the light pipe portion 27 is sectioned into the A1 section, the A2 section, and the A3 section. The A2 section has an external surface 20 that is textured while the A1 and A3 sections each has a non-textured external surface.

In some embodiments, an external surface or an internal surface, or both the external and internal surfaces, of a first section of the light pipe portion 37 is textured in a first pattern. Additionally, the external surface or the internal surface, or both the external and internal surfaces, of a second section of the light pipe portion 37 is textured in a second pattern different than the first pattern. For example, as shown in FIGS. 3-4, the light pipe portion 37 is sectioned into multiple sections B1-B5. The B2 section has an external surface 31 that is textured in a first pattern. The B4 section has an external surface 32 that is textured in a second pattern different than the first pattern of the textured surface 31. Meanwhile, sections of the light pipe portion 37 neighboring sections B2 and B4, such as the sections B1, B3 and B5, are not textured either internally or externally.

In some embodiments, an external surface or an internal surface, or both the external and internal surfaces, of the distal end 28 or 38 is textured in a first pattern. Additionally, an external surface or an internal surface, or both the external and internal surfaces, of at least a section of the light pipe portion 27 or 37 is textured in a second pattern different than the first pattern. For example, as shown in FIGS. 1-2, the distal end 28 has an external surface 21 that is textured in a given pattern while section A2 of the light pipe portion 27 has an external surface 20 that is textured in a different pattern. As another example, as shown in FIGS. 3-4, the distal end 38, also labeled as section B6, has an external surface 33 that is textured in a certain pattern while either section B2 or section B4 of the light pipe portion 37 has an external surface 31 or 32, respectively, that is textured in a different pattern.

In some embodiments, at least a textured surface comprises a scratched surface. In one embodiment, the scratching may be done by laser. In another embodiment, the scratching may be done mechanically by cutting. Alternatively, the scratching may be done chemically by suitable means.

In some embodiments, at least a textured surface comprises a painted surface.

In some embodiments, at least a textured surface comprises a surface with optical coating.

In some embodiments, at least a textured surface comprises a surface-machined surface.

In some embodiments, at least a textured surface comprises a two-dimensional texture. Additionally or alternatively, the textured surface comprises a three-dimensional texture. For example, the textured surface 20, 21, 31, 32 or 33 may comprise two-dimensional texture, three-dimensional texture, or both two-dimensional texture and three-dimensional texture.

In some embodiments, the light guide device 25 is made of a thermoplastic material. The thermoplastic material may be acrylic or a type of polycarbonate material. Alternatively, the light guide device 25 is made of glass or another transparent material.

In some embodiments, a textured surface may be textured by at least one of the following: scratching the respective surface, painting the respective surface, optical-coating the respective surface, surface-machining the respective surface, texturing the respective surface by laser, or melting the respective surface by laser.

In those embodiments where the apparatus 1001 comprises the illumination device 12. The illumination device 12 may comprise an LED light source 11 which includes one or more LEDs. Alternatively, the illumination device 12 may comprise a laser diode (LD) light source which includes one or more LDs.

The apparatus 1001 is illustrated in FIGS. 1-2 and FIGS. 3-4 as unassembled. That is, as shown in FIGS. 1-4, the illumination device 12 and the light guide device 25 are not assembled. However, FIGS. 1-2 also show a light source 15 to indicate the location of the light source 11 of the illumination device 12 when the illumination device 12 and the light guide device 25 are assembled together to form the apparatus 1001. Likewise, FIGS. 3-4 also show a light source 35 to indicate the location of the light source 11 of the illumination device 12 when the illumination device 12 and the light guide device 30 are assembled together to form the apparatus 1001.

In some embodiments, the apparatus 1001 may further comprise a power supply 13 coupled to the illumination device 12 via wires 14 to provide electric power to the illumination device 12. In some embodiments, the power supply 13 comprises an alternating current (AC) power adapter and a power converter to convert an AC power to a direct current (DC) power. In some embodiments, the power supply 13 comprises a battery. In other embodiments, the power supply 13 comprises both an AC power adapter (with an AC-to-DC converter) and a battery.

FIGS. 5-6 illustrate a light guide device 40 in accordance with one embodiment of the present disclosure.

The light guide device of the present disclosure may come in difference sizes and shapes. The light guide device 25 of FIGS. 1-2 and the light guide device 30 of FIGS. 3-4 each has a generally tubular shape. As an alternative example, FIGS. 5-6 show a light guide device 40 that has a generally rectangular shape. The light guide device 40 comprises a light pipe portion 47, an opening 46, and a distal end 48 longitudinally opposite from the opening 46. As shown in FIGS. 5-6, the distal end 48 has an external surface 42 that is textured in one pattern while a section of the light pipe portion 47 has an internal surface 41 that is textured in a different pattern.

FIGS. 5-6 show a light source 45 to indicate the location of the light source 11 of the illumination device 12 when the illumination device 12 and the light guide device 40 are assembled together to form the apparatus 1001.

### Illustrative Operation

FIG. 7 illustrates the apparatus 1001 in operation in accordance with one embodiment of the present disclosure.

As shown in FIG. 7, the LED light source 11 of the illumination device 12 is received in the opening 26 of the light guide device 25 and emitting light. Regardless of the texturing, pattern or method used to create thereof, a textured surface of the light guide device 25 can be considered a “light escape zone”. That is, light emitted by the LED light source 11 escapes from the different sections of the light guide device 25 at varying degrees. In the example shown in FIG. 7, the distal end 28, corresponding to section A4 of the light guide device 25, has an external surface 21 that is textured in a first pattern while section A2 of the light pipe portion 27 has an external surface 20 that is textured in a second pattern different than the first pattern of section A4, such that more light escapes from the light guide device 25 through section A4 than through section A2. At the same time, more light escapes from the light guide device 25 through either section A4 or section A2 than through any other section of the light guide device 25 since the surfaces of the other sections of the light guide device 25 are not textured.

In the event that the apparatus 1001 is designed for use in a medical application, such as for illumination of the body cavity of a patient during a surgical operation, the light guide device 25 may be designed so that more than 80% of the light emitted by the LED light source 11 escapes from section A4 of the light guide device 25, approximately or less than 10% of the light emitted by the LED light source 11 escapes from section A2 of the light guide device 25, and less than 5% of the light emitted by the LED light source 11 escapes from each of section A1 and section A3 of the light guide device 25. This would result in a majority of the lighting being uniformly scattered or distributed near the bottom, or section A4, a minority of the lighting being around section A2, and weak lighting being around sections A1 and A3. In a surgical setting, it may be most desirable to have the majority of the lighting around the bottom portion, or section A4, of the light guide device 25 since the bottom portion of the light guide device 25 would be inserted deepest into the body cavity of the patient where lighting is needed the most.

As would be appreciated by one skilled in the art, the amount and location of lighting escaping from a light guide device, such as the light guide device 25, 30 or 40, can be designed by adjusting the size, shape, texturing and location of the textured surfaces of the light guide device 25, 30, 40. Accordingly, the distribution of lighting of high uniformity can be precision-controlled depending on the specific needs of the application in concern.

### Illustrative Method

FIG. 8 is a process 100 of manufacturing a portion of an illumination apparatus in accordance with one embodiment of the present disclosure.

At 102, a light guide device is provided. The light guide device, such as the light guide device 25 of FIGS. 1-2, the light guide device 30 of FIGS. 3-4 or the light guide device 40 of FIGS. 5-6 for example, includes a hollow light pipe portion, an opening configured to receive an illumination device therein, and a distal end longitudinally opposite from the opening.

At 104, a respective surface of either or both of the light pipe portion and the distal end is textured to have two-dimensional texturing, three-dimensional texturing, or both.

In some embodiments, texturing a respective surface of either or both of the light pipe portion and the distal end may be done by at least one of the following: scratching the respective surface, painting the respective surface, optical-coating the respective surface, surface-machining the respective surface, texturing the respective surface by laser, or melting the respective surface by laser.

In some embodiments, three-dimensional texturing may be done by three-dimensional scattering which may entail mixing some particles as a scattering point, e.g., at internal surface 41 of the light pipe portion 47 of the light guide device 40 of FIGS. 5-6. Light-scattering media can be created by embedding a dust inside of the light pipe portion 47.

### CONCLUSION

The above-described techniques pertain to an apparatus that provides precision-controlled distribution of LED lighting of high uniformity. Although the techniques have been described in language specific to certain applications, it is to be understood that the appended claims are not necessarily limited to the specific features or applications described herein. Rather, the specific features and applications are disclosed as exemplary forms of implementing such techniques. For instance, although the techniques have been described in the context of a medical application, the techniques may be applied in any other suitable context. Additionally, although the description is generally directed to LED-based lighting, the techniques may be implemented in applications where lighting is based on one or more laser diodes.

What is claimed is:

1. An apparatus comprising:
a light guide device including a hollow light pipe portion, an opening, and a distal end longitudinally opposite from the opening, the opening configured to receive at least a portion of an illumination device therein, either or both of the light pipe portion and the distal end having a textured surface thereof.

2. The apparatus of claim 1, wherein an external surface or an internal surface, or both the external and internal surfaces, of a first section of the light pipe portion is textured, and wherein the external surface or the internal surface, or both the external and internal surfaces, of a second section of the light pipe portion is non-textured.

3. The apparatus of claim 1, wherein an external surface or an internal surface, or both the external and internal surfaces, of a first section of the light pipe portion is textured in a first pattern, and wherein the external surface or the internal surface, or both the external and internal surfaces, of a second section of the light pipe portion is textured in a second pattern different than the first pattern.

4. The apparatus of claim 1, wherein an external surface or an internal surface, or both the external and internal surfaces, of the distal end is textured in a first pattern, and wherein an external surface or an internal surface, or both the external and internal surfaces, of at least a section of the light pipe portion is textured in a second pattern different than the first pattern.

5. The apparatus of claim 1, wherein the textured surface comprises a scratched surface.

6. The apparatus of claim 1, wherein the textured surface comprises a painted surface.

7. The apparatus of claim 1, wherein the textured surface comprises a surface with optical coating.

8. The apparatus of claim 1, wherein the textured surface comprises a surface-machined surface.

9. The apparatus of claim 1, wherein the textured surface comprises a two-dimensional texture, a three-dimensional texture, or both.

10. The apparatus of claim 1, wherein the light guide device is made of a thermoplastic material.

11. The apparatus of claim 10, wherein the thermoplastic material comprises acrylic or polycarbonate.

12. The apparatus of claim 1, further comprising:
a first illumination device a portion of which is received in the opening of the light guide device.

13. The apparatus of claim 12, wherein the first illumination device comprises a light-emitting diode (LED) or a laser diode (LD).

14. The apparatus of claim 12, further comprising:
a power supply coupled to provide electric power to the first illumination device.

15. The apparatus of claim 14, wherein the power supply comprises an alternating current (AC) power adapter and a power converter to convert an AC power to a direct current (DC) power.

16. The apparatus of claim 14, wherein the power supply comprises a battery.

17. An apparatus comprising:
an illumination device;
a power supply coupled to provide electric power to the illumination device; and
a light guide device including a hollow light pipe portion, an opening, and a distal end longitudinally opposite from the opening, the opening configured to receive at least a portion of the illumination device therein, either or both of the light pipe portion and the distal end having a textured surface thereof.

18. The apparatus of claim 17, wherein a first section of the light pipe portion is non-textured, wherein the external surface or the internal surface, or both the external and internal surfaces, of a second section of the light pipe portion is textured in a first pattern, and wherein an external surface or an internal surface, or both the external and internal surfaces, of the distal end is textured in a second pattern different than the first pattern.

19. A method of manufacturing a portion of an illumination apparatus, the method comprising:
providing a light guide device having a hollow light pipe portion, an opening configured to receive an illumination device therein, and a distal end longitudinally opposite from the opening; and
texturing a respective surface of either or both of the light pipe portion and the distal end.

20. The method of claim 19, wherein texturing a respective surface of either or both of the light pipe portion and the distal end comprises texturing the respective surface of either or both of the light pipe portion and the distal end by at least one of the following:
scratching the respective surface;
painting the respective surface;
optical-coating the respective surface;
surface-machining the respective surface;
texturing the respective surface by laser; or
melting the respective surface by laser.
